(19) United States
(12) Patent Application Publication
(10) Pub. No.: US 2013/0201343 A1
(43) Pub. Date: Aug. 8, 2013

(54) LENSELESS COMPRESSIVE IMAGE ACQUISITION

(71) Applicants: Hong Jiang, Warren, NJ (US); Gang Huang, Monroe Township, NJ (US); Kim N. Matthews, Watchung, NJ (US); Paul A. Wilford, Bernardsville, NJ (US)

(72) Inventors: Hong Jiang, Warren, NJ (US); Gang Huang, Monroe Township, NJ (US); Kim N. Matthews, Watchung, NJ (US); Paul A. Wilford, Bernardsville, NJ (US)

(21) Appl. No.: 13/658,900

(22) Filed: Oct. 24, 2012

Related U.S. Application Data
(63) Continuation-in-part of application No. 13/367,413, filed on Feb. 7, 2012.

(51) Int. Cl. H04N 5/225; H04N 5/33

(52) U.S. Cl. 348/164; 348/222.1; 348/E05.024; 348/E05.09

(57) ABSTRACT

An exemplary lensless compressive imaging device may include a micro mirror array having a plurality of mirror elements that are individually controllable for selectively directing light reflecting from the micro mirror array. A detector detects light reflected from at least one of the mirror elements. A processor provides compressive image information based on the detected light.

### CROSS-REFERENCE TO RELATED APPLICATIONS

This application is a continuation-in-part of co-pending U.S. patent application Ser. No. 13/367,413 which was filed on Feb. 7, 2012.

1. Technical Field

This disclosure generally relates to image acquisition. More particularly, this disclosure relates to devices and methods for lensless compressive image acquisition.

2. Description of the Related Art

Various devices are known for image acquisition. Conventional cameras were, for many years, based on capturing images on film. More recently, devices such as cameras have included digital imaging components. Many contemporary digital image or video devices are configured for acquiring and compressing large amounts of raw image or video data.

One drawback associated with many digital systems is that they require significant computational capabilities. Another potential drawback is that multiple expensive sensors may be required.

### SUMMARY

According to an embodiment, a lensless compressive imaging device may include a micro mirror array having a plurality of mirror elements that are individually controllable for selectively directing light reflecting from the micro mirror array. A detector detects light reflected from at least one of the mirror elements. A processor provides compressive image information based on the detected light.

According to an embodiment, a lensless compressive image acquisition method includes controlling a plurality of mirror elements of a micro mirror array, respectively, for selectively directing light reflecting from the micro mirror array. Light reflected from at least one of the minor elements is detected. Compressive image information is provided based on the detected light.

Various embodiments and their features will become apparent to those skilled in the art from the following detailed description. The drawings that accompany the detailed description can be briefly described as follows.

### BRIEF DESCRIPTION OF THE DRAWINGS

FIG. 1 schematically illustrates an example lensless image acquisition device.

FIG. 2 schematically illustrates selected components of a lensless image acquisition device and features of a process for acquiring image information.

FIG. 3 schematically illustrates an example feature of an example embodiment of a lensless image acquisition device.

### DETAILED DESCRIPTION

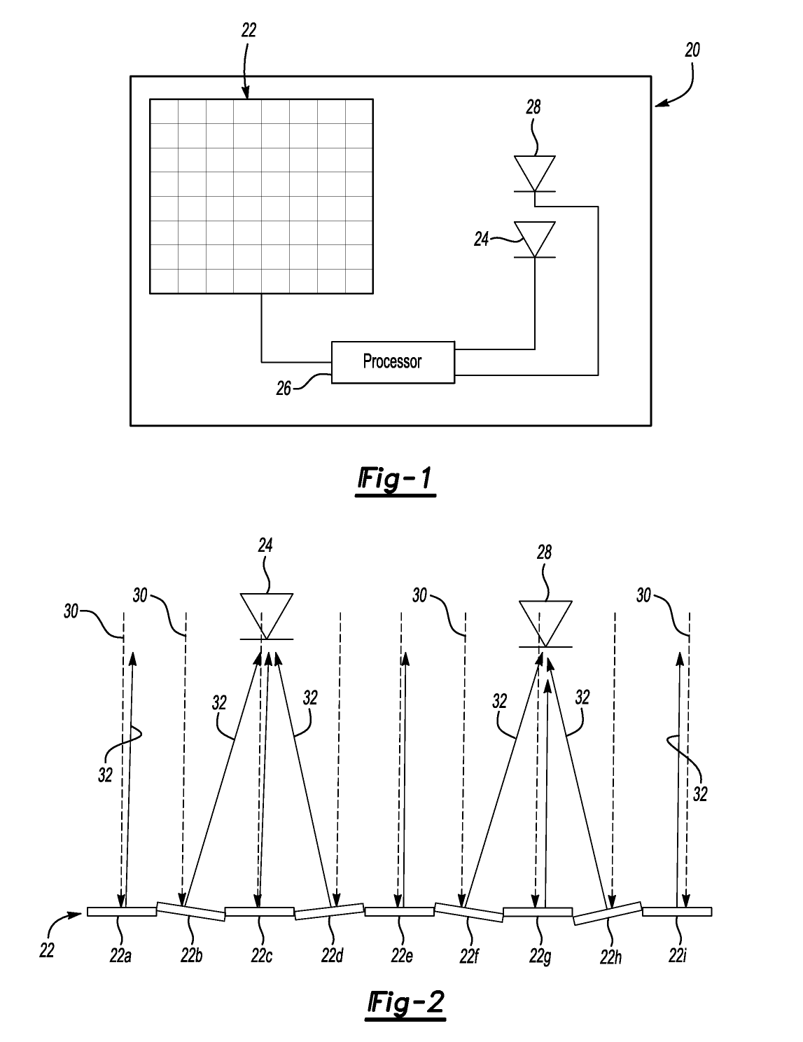

FIG. 1 schematically illustrates a lensless image acquisition device 20. A micro minor array 22 includes a plurality of individual minor elements. The micro minor array 22 is controllable for selectively orienting each of the individual minor elements. The orientation of each of the minor elements controls how light reflecting from those elements is directed by the micro minor array 22.

At least one detector 24 is associated with the micro minor array 22. The detector 24 is configured for detecting light reflecting from at least one of the minor elements of the micro minor array 22. In one example, the detector 24 is configured for detecting visible light. In another example, the detector 24 is configured for detecting infrared light. In other examples, the detector 24 is configured for detecting non-visible light that is outside of the infrared range of the electromagnetic spectrum. On example embodiment is useful for hyperspectral imaging.

The detector 24 in different embodiments may detect a variety of radiation types that are not visible and, therefore, not typically referred to as light.

The term “light” is used in this description to refer generically to different types of light or radiation within the electromagnetic spectrum without necessarily being limited to visible light. Therefore, the term “light” should be understood to include more than just visible light.

One feature of the example of FIG. 1 is that the micro mirror array 22 allows for gathering compressive image information from light of differing wavelengths. Another feature is that no lens is required and the detector 24 detects light from an object reflected from the minors of the micro minor array 22.

A processor 26 is associated with the micro minor array 22 for selectively controlling the orientation of each of the minor elements. The processor 26 includes data storage or has associated data storage with information regarding desired orientations of the mirror elements for different image acquisition situations. In one example, the data storage includes information regarding a plurality of bases that indicate the mirror orientations for a particular image acquisition process. Each basis includes an orientation for each of the minor elements. A plurality of different bases allows for a variety of image acquisition capabilities using the micro minor array 22 and the single sensor 24 without requiring a lens.

The processor 26 is configured for gathering information from the detector 24 based on reflected light detected by the detector 24. The processor 26 provides compressive image information based on the detected light. Known techniques are used in one example for processing and formatting the provided compressive image information.

In some examples, the processor 26 is configured for providing image information or image files. In other examples, the processor 26 is configured to provide information to another processor or device that generates an image.

The example of FIG. 1 also includes another detector 28. In one example, the detector 24 is configured for one type of light detection (e.g., visible light or infrared light) while the other detector 28 is configured for a different type of light detection (e.g., infrared light or visible light). Having two different detectors that are capable of two different types of light detection allows the example device 20 to be used in a wider range of image acquisition situations. Additionally, the processor 26 may gather information from each of the detectors 24 and 28 and combine the information from the different types of detected light for generating compressive image information that may be utilized for generating a single image based on the different types of light.

In another example, the detectors 24 and 28 are configured similar to each other so that they both are capable of detecting light from within the same range of the electromagnetic spectrum. For example, the detectors 24 and 28 may both be configured for detecting visible light or they both may be configured for detecting infrared light.

One feature of the example of FIG. 1 is that it is possible to use a single detector and to take image measurements a significantly fewer number of times compared to the number of pixels associated with contemporary cameras and the images they produce. Additionally, the ability to use a single detector for a particular type of image acquisition allows for more readily incorporating multiple detectors of different types so that the image acquisition device 20 has a wider range of image capturing capability. Further, the example device 20 is lensless.

FIG. 2 schematically illustrates selected mirror elements of the micro mirror array 22 situated according to a basis utilized by the processor 26 for controlling the micro minor array 22. Light incident on the micro minor array 22 is schematically illustrated by the broken lines 30 and light reflecting from the mirror elements is schematically represented by the solid lines 32. As can be appreciated from FIG. 2, some of the mirror elements are oriented or tuned to direct reflected light toward one or more of the sensors 24 and 28. For example, the minor elements 22B, 22C and 22D are each oriented such that the reflected light 32 from those mirror elements is directed toward the sensor 24 where that reflected light can be detected by that detector. The minor elements 22F, 22G and 22H are each oriented in a manner that the reflecting light 32 from those minor elements is directed toward the sensor 28.

By selectively controlling the orientation of each of the minor elements according to the different bases used by the processor 26, a variety of sets of image information becomes available. For each basis (i.e., selected orientation of the individual minor elements), each detector will provide a different output. Each detector output can be considered a compressive measurement that is utilized by the processor 26 to generate compressive image information. In other words, each bases used for controlling the micro mirror array 22 provides a compressive measurement from each detector. Each of the individual compressive measurements may be viewed as the detected sum of the reflected light from each mirror element during a particular measurement according to a particular basis.

For devices that include more than one detector, such as the examples of FIGS. 1 and 2, it is possible to obtain more than one compressive measurement simultaneously using a single basis. This can increase the number of individual measurements obtained within a given time.

In some embodiments multiple detectors are configured for detecting the same type of light, which allows for obtaining multiple images based on that type of light simultaneously. In some embodiments the detectors are configured for detecting different types of light, which allows for obtaining multiple images, each of which is based on a different type of light, simultaneously.

In some examples, the relative positions of the micro mirror array 22 and the one or more detectors 24, 28 are adjustable for changing a distance between the micro mirror array and at least one of the detectors. A known linear actuator is included in one example embodiment for selectively altering the distance between the detectors and the micro mirror array. Another example includes the ability to change the position of detectors relative to each other for obtaining different image information in different manners depending on the needs of a particular situation.

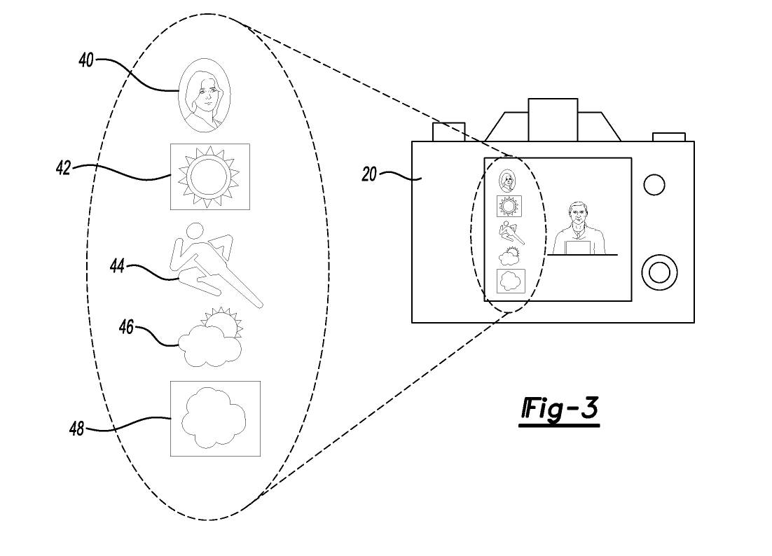

FIG. 3 schematically illustrates an example image acquisition device 20 that is utilized like a camera. This example includes a plurality of options that are selectable for different types of image acquisition needs. In the illustrated example, a user is presented with an option 40 for a portrait mode, an option 42 for image acquisition in bright outdoor light conditions, an option 44 for high speed image acquisition such as during sport activities, an option 46 that is useful for image acquisition during questionable lighting conditions and an option 48 for image acquisition under dark conditions. Selecting one of the options 40-48 provides information to the processor 26 such that the processor 26 is able to select at least one appropriate basis for the needed image acquisition. Additionally, selecting one or more of the options 40-48 provides information to the processor 26 for selecting which type of detector would be best suited for a particular image capturing session for embodiments in which different types of detectors are included.

Each basis may include a selected number of the mirror elements oriented or tuned for directing reflected light toward a particular sensor. Mirror elements that are oriented for directing reflected light in this manner may be considered to be active or on according to a particular basis. Other mirror elements that do not reflect light toward a particular detector may be considered to be inactive or off according to a particular basis. Of course, some mirror elements may be considered active or on for one of the detectors while, at the same time, be considered inactive or off relative to another of the detectors. In the example of FIG. 2, the mirror element 22 may be considered active relative to the detector 24 but inactive relative to the detector 28. The minor elements 22A, 22E and 22I would be considered to be inactive or off relative to both of the detectors 24 and 28 in the example of FIG. 2 because the light reflected from those mirror elements does not come within the detection field of either of the detectors 24 or 28.

The number of mirror elements and detectors shown in the illustrations is for description purposes only. Those skilled in the art will realize that various configurations of a micro minor array and various configurations of one or a plurality of detectors may be utilized consistent with the principles of operation described above. The disclosed example embodiments provide an image acquisition device and method that is capable of generating compressive image information based upon at least one of visible light or infrared light.

The preceding description is exemplary rather than limiting in nature. Variations and modifications to the disclosed examples may become apparent to those skilled in the art that do not necessarily depart from the essence of the disclosed embodiments. The scope of legal protection can only be determined by studying the following claims.

We claim:

1. A lensless compressive imaging device comprising:
a micro mirror array including a plurality of mirror elements that are individually controllable for selectively directing light reflecting from the micro minor array;
a detector that is configured to detect light reflected from at least one of the minor elements; and
a processor that is configured to provide compressive image information based on the detected light.

2. The device of claim 1, wherein the detected light comprises visible light.

3. The device of claim 1, wherein the detected light comprises infrared light.

4. The device of claim 1, comprising an infrared detector configured for detecting infrared light and wherein the detector is configured for detecting visible light.

5. The device of claim 4, wherein the processor is configured to provide the compressive image information based on detected light from each of the detectors, respectively.

6. The device of claim 4, wherein a first set of the mirror elements reflect visible light toward the detector and a second set of the mirror elements reflect infrared light toward the infrared detector.

7. The device of claim 1, wherein at least one of the detector or the micro minor array is moveable relative to the other for selectively varying a distance between the micro minor array and the detector.

8. The device of claim 1, wherein orientations of the minor elements are controlled according to a basis and the basis is selectively varied.

9. A lensless compressive image acquisition method comprising the steps of:
controlling a plurality of mirror elements of a micro mirror array, respectively, for selectively directing light reflecting from the micro mirror array;
detecting light reflected from at least one of the mirror elements; and
providing compressive image information based on the detected light.

10. The method of claim 9, wherein the detected light comprises visible light.

11. The method of claim 9, wherein the detected light comprises infrared light.

12. The method of claim 9, wherein detecting the reflected light comprises
detecting infrared light; and
detecting visible light.

13. The method of claim 12, wherein detecting the reflected light comprises
detecting the visible light using a first detector; and
detecting the infrared light using a second detector.

14. The method of claim 12, wherein providing the compressive image information comprises
providing compressive image information based on detected visible light; and
providing compressive image information based on detected infrared light.

15. The method of claim 12, comprising
selectively controlling a first set of the mirror elements for reflecting visible light toward one detector; and
selectively controlling a second set of the mirror elements for reflecting infrared light toward another detector.

16. The method of claim 9, comprising
selectively varying a distance between the micro mirror array and a detector that is configured to detect the reflected light.

17. The method of claim 9, comprising
selectively controlling orientations of the mirror elements according to a basis; and
selectively varying the basis.
